(19) United States
(12) Patent Application Publication
(10) Pub. No.: US 2014/0332706 A1
(43) Pub. Date: Nov. 13, 2014

(54) Roll Coolant Valve for Rolling

(71) Applicants: Shoichi Toyonaga, Narashinoshi (JP); Koji Akaya, Ichiharashi (JP); Yoshihito Nakazato, Chuoku (JP)

(72) Inventors: Shoichi Toyonaga, Narashinoshi (JP); Koji Akaya, Ichiharashi (JP); Yoshihito Nakazato, Chuoku (JP)

(21) Appl. No.: 14/114,166

(22) PCT Filed: Apr. 24, 2012
(86) PCT No.: PCT/JP2012/060999

§ 371 Date: Mar. 9, 2014

(30) Foreign Application Priority Data
Apr. 28, 2011 (JP) 2011-101833

(51) Int. Cl. B21B 27/10; F16K 31/06

(52) U.S. Cl. CPC B21B 27/10; F16K 31/0658; B21B 2027/103
USPC 251/129.15

(57) ABSTRACT

The invention of the present application addresses the problem of providing a normally open roll coolant valve. This roll coolant valve includes: a valve body (1); an end cover (8) fitted into one end of the valve body (1); an annular coil (11) provided along the inside wall of the valve body (1); a stationary core (5) having a form whereby a hollow disc-shaped base part and a hollow annular part extending therefrom are formed integrally, and arranged so as to make contact with the coil (11); a needle (9) that is capable of sliding within the aforementioned hollow annular part and making contact with the rear aperture of a poppet (3) to seal this aperture; a movable core (4) that has the needle (9) and is arranged so as to be capable of sliding on the inner surface of the coil (11); an elastic element (12) provided between the stationary core (5) and the movable core (4); and a circuit for supplying power to the aforementioned coil.

### TECHNICAL FIELD OF THE INVENTION

The present invention relates to a roll coolant for rolling.

### BACKGROUND

In a rolling process, a coolant such as kerosene, emulsion of oil and water, or water is jetted to a work roll for controlling local expansion of a rolling material and local shape distortions. The plural spray nozzles which jet the coolant are arranged along the width of the work roll of the rolling material, and the coolant is jetted from the spray nozzle to the work roll. The coolant jet is ON/OFF controlled independently in each spray nozzle.

By the ON/OFF control of a coolant jet, a jetted part of the work roll is cooled and contracted and, on the other hand, a non jetted part of the work roll expands due to a heat during rolling. Therefore, in the expanded part of the work roll, the rolling material becomes thinner. In the contracted part of the work roll, an elongation of the rolling material is restrained. In other words, the part of the rolling material that is jetted with the coolant tends not to be elongated, and the part of the rolling material that is not jetted with the coolant tends to be elongated.

Generally, in a rolling controller for controlling a shape of a plated work roll, a target shape is set and an actuator of the spray nozzle and the work roll are operated so that the detected shape changes toward that of the target shape. The ON/OFF of the spray nozzle can be controlled by various methods. In general, if a part of the rolling material is too elongated relative to the target shape, coolant is jetted to the part and the elongation is inhibited. Conversely, if a part of the rolling material is less elongated than the target shape, coolant is not jetted to the part and elongation is promoted.

The ON/OFF control of the coolant jet is done by the roll coolant valve. The valve is turned on and off by ON/OFF of electricity. All conventional coolant valves have been the type that are normally closed.

FIG. 2 shows a conventional roll coolant valve that normally closed. The valve comprises a valve body 1, an end cover 8, a coil 11, a fixed core 5, a movable core 4, an elastic component 12 and a poppet 3. Fixed core 5 and movable core 4 are arranged along coil 11 disposed in valve body 1. Elastic component 12 is provided between a front surface of the fixed core and a rear surface of the movable core. When the coil is not energized, elastic component 12 pushes movable core 4 to a direction of a discharging opening of the valve body, thereby pushing poppet 3 and closing the valve. The movable core shown on the right of FIG. 2 is in a closed position. When the coil is energized, movable core 4 is pulled to the direction of and contacts the fixed core. Poppet 3 is pushed by a fluid and is moved together with movable core 4, and the valve is opened. A position of the movable core shown on the left of FIG. 2 is an opened position.

A valve of a type that is normally open has been desired by the customer for various purposes. However, because many changes are necessary, a valve of a type that is normally open has not been provided.

### SUMMARY OF THE INVENTION

The present invention aims to provide a novel roll coolant valve of a default open type.

The present invention relates to a roll coolant valve comprising a valve body, an end cover, a coil, a needle, a fixed core, a movable core, an elastic component, a poppet and a power supply circuit that supplies electric power to the coil,

wherein the end cover is set in an end of the valve body to form a cavity having a discharging opening,

the coil is an annular hollow coil arranged along the inner sidewall of the valve body,

the fixed core having a shape which is a combination of an annular hollow basic disk and a hollow cylindrical portion extending from the basic disk, a rear surface of the basic disk being arranged to contact with a front edge surface of the coil, the surface of the basic disk being arranged nearly at a right angle relative to a longitudinal direction of the valve body, the hollow cylindrical portion being arranged to contact with an inner surface of the annular hollow coil and fixed in the cavity,

the movable core being arranged in a cavity to slide along the inner surface of the annular hollow coil,

the movable core being equipped with a needle that is arranged to slide along an inner surface of the hollow cylindrical portion of the fixed core, a front portion of the needle able to contact and close a rear opening of the poppet,

the hollow cylindrical portion of the fixed core, which extends from the basic disk rearwardly (i.e., in a backward direction), has a thick wall part at a forward portion of the cylindrical portion so that a step-wise portion is formed, the needle of the movable core having a thick portion that corresponds to the thick portion of the hollow cylindrical portion so that a step-wise portion is formed, an elastic component being provided between the step-wise portion of the fixed core and the step-wise portion of the needle,

the poppet having an opening that penetrates therethrough at its center and arranged to slide in the valve body,

the valve body further comprising a channel that communicates with coolant outside of the valve, the coolant being able to flow in a space between the rear end of the movable core and the end cover through the channel.

In the present invention, the term “roll coolant valve” means a valve that controls ON/OFF of the jet of the coolant to the work roll during a rolling process. The coil can be made from any material that can generate magnetic force when energized. The strength of its magnetic force can be suitably adjusted.

The needle is integrated with a body of the movable core, for example, by a screw.

The roll coolant valve of the present invention optionally comprises a stopper and spacer. The stopper is arranged to contact the end cover and can be formed so that the stopper receives an end portion of the movable core. In addition, the coil, etc., can be secured in a suitable place by providing the spacer.

When the stopper is provided, a channel that communicates with coolant outside of the cavity is provided so that the coolant can flow between the movable core's rear end and the stopper.

### ADVANTAGEOUS EFFECTS OF THE INVENTION

A novel, normally open roll coolant valve is provided by the present invention. When a normally open type valve is safer to operate than a normally closed type valve, a customer has the ability to select the new open type valve. The electrical power cost of a normally open type valve is lower than that of a normally closed type.

Further, by providing a voltage control resistance circuit to a power supply circuit and employing a resistor R composed of 5 W-30 W coil, a significant decrease of the electric power is accomplished.

### BRIEF EXPLANATION FO THE DRAWINGS

FIG. 1 shows a cross sectional view of a normal open type roll coolant valve of the present invention.

FIG. 2 shows a cross sectional view of a conventional normal close type roll coolant valve.

FIG. 3 shows an exemplary voltage control resistance circuit used in the present invention.

FIG. 4 shows an exemplary voltage waveform provided by the voltage control resistance circuit used in the present invention.

### DETAILED EXPLANATION OF THE INVENTION

The roll coolant valve of the present invention is explained in detail below.

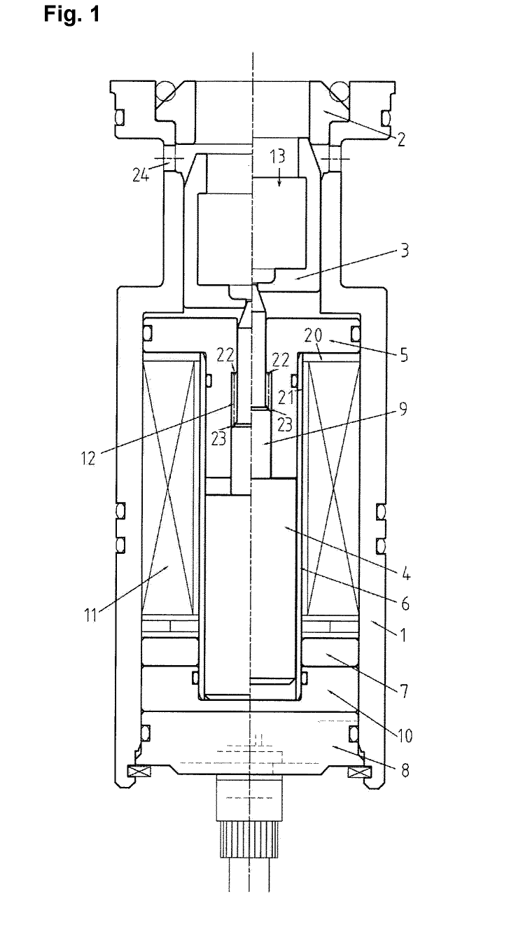

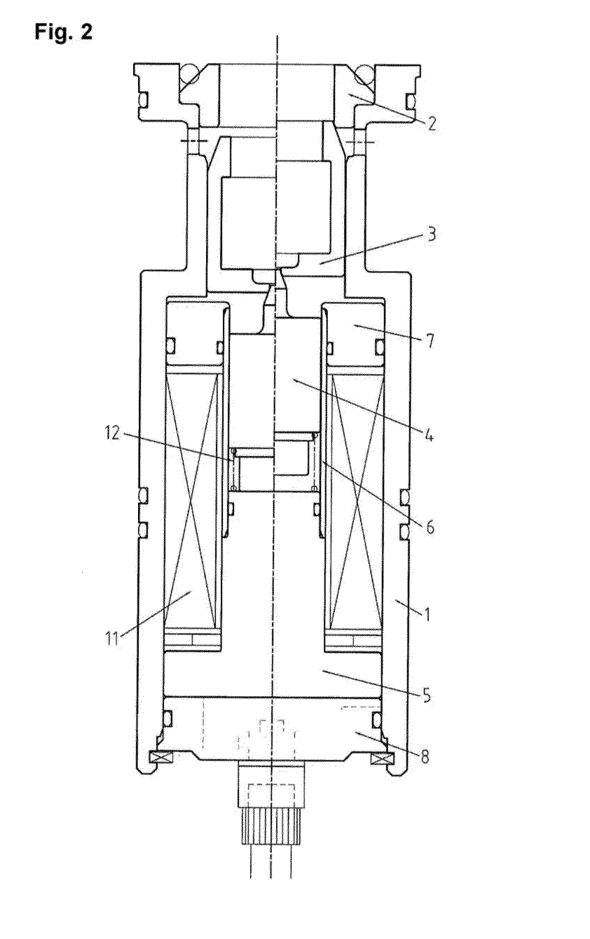

The coolant valve of the present invention shown in FIG. 1 comprises a valve body 1, an end cover 8, a coil 11, a needle 9, a fixed core 5, a movable core 4, a poppet 3, a spring 12 and a power supply circuit (not shown in the figure). End cover 8 is set in an end of valve body 1 so that a cavity having an opening is formed. The opening works as a discharging opening 13 for coolant from the valve. In the specification of the present application, a direction toward the discharging opening is referred to as forward, and a direction toward the end cover is referred to as backward. A direction that connects the end cover and the discharging opening is referred to as longitudinal.

Coil 11 is an annular hollow coil arranged along the inner sidewall of the valve body. The fixed core has a shape, which is a combination of an annular hollow basic disk and a hollow cylindrical portion extending from the basic disk, a rear surface of the basic disk contacting a front edge surface of the coil, the surface of the basic disk is at almost a right angle relative to a longitudinal direction of the valve body, the hollow cylindrical portion being arranged to contact an inner surface of the annular hollow coil. The fixed core is firmly secured to the valve body so as not to move.

Movable core 4 is arranged in a cavity to be slidable with inner surface 21 of the annular hollow coil. Movable core 4 is equipped with needle 9 that is slidably arranged with an inner surface of the hollow cylindrical portion of the fixed core, a front portion of needle 9 capable of contacting and closing a rear opening of the poppet.

Movable core 4 is integrally formed with needle 9.

The hollow cylindrical portion of the fixed core extending from the basic disk of fixed core 5 in a backward direction has a thick wall part at a forward portion of the cylindrical portion so that a step-wise portion 22 is formed. The needle has a thick portion that corresponds to the thick portion of the hollow cylindrical portion so that a stepwise portion 23 is formed. An elastic component is provided between the stepwise portion 22 of the fixed core and the stepwise portion 23 of the needle. A spring is typically used as the elastic component. However, any component that can apply enough power can be used, not just a spring.

Poppet 3 is disposed in valve body 1 and is slidable within valve body 1. The poppet 3 has an opening that penetrates its center. The opening is preferably tubular and is formed as coaxial to a center line of the poppet. A rear end of the opening is shaped to seal the opening by contacting to the front tip of needle 9.

A cross section of needle 9, fixed core 5, movable core 4 and poppet 3 is circular. They are placed coaxially, and their center lines overlap the centerline of valve body 1.

In FIG. 1, opening 24 that communicates the cavity with the coolant outside of the valve allows coolant to flow into the cavity of the valve.

The roll coolant valve of the present invention comprises a channel that communicates inside and outside of the cavity so that the coolant can flow between the movable core's rear end and the end cover. For example, this channel may be formed by providing a suitable space between the needle and the fixed core or between the movable core and the coil. Moreover, a small penetrated hole can be provided at a suitable position of the valve body so as to maintain communication between the interior of the valve body and the coolant outside the valve. Because coolant is pressurized, when the movable core moves and a space or low pressure region is formed between the movable core's rear end and the end cover, coolant can flow into the region. The pressure of the coolant assists movement of the movable core and a smooth and prompt movement of the movable core becomes possible.

A guide can be provided on a surface of the coil so as to protect the coil and assist smooth movement. In that case, the fixed core and the movable core are placed in contact with the guide.

Movement of the coolant valve of the present invention is described below.

When the coil is not energized, the fixed core is not magnetized. Because movable core 4 is pushed backward by elastic component 12, no pressure is applied to the poppet by the movable core. Therefore, the poppet is pushed backward by the pressure of the coolant, and the poppet contacts a front portion of the needle. Thus, a space is created between the poppet and a seat 2, and the valve is opened.

When the coil is energized, the fixed core is magnetized. The movable core pushes the elastic component and moves toward the fixed core. When the movement of the movable core starts, coolant flows into the cavity through the channel that connects the inside of the cavity and the coolant outside of the cavity and assists movement of the movable core. When the movable core is moved forward, the needle touches a rear opening of the poppet and moves the poppet forward. Then the poppet touches seat 2 and closes the coolant valve. This condition is shown on the right side of FIG. 1. Seat 2 contacts the poppet and limits the travel range of the poppet. The seat can be integrally formed with the valve body or formed separately and combined.

Each above-mentioned material used in the coolant valve of the present invention can be made from a metallic material that has sufficient strength, such as stainless steel, preferably SUS304 and/or SUS430. The preferred material for the fixed core is one that has excellent magnetic performance. It is easy for those skilled in the art to select preferable materials depending on a kind of coolant, temperature of the coolant and a contact time with the coolant, etc.

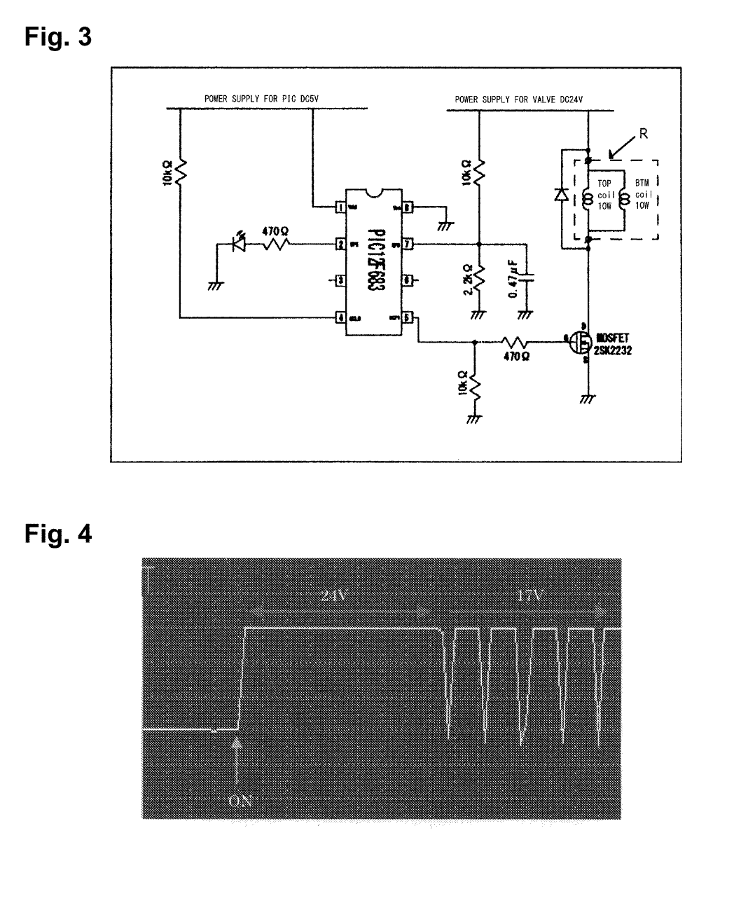

In the coolant valve of the present invention, a voltage control resistance circuit (VCR circuit) can be provided to the power supply circuit. FIG. 3 shows an exemplary circuit. The resistance part shown by R in the figure is a 5-30 W coil. If R is lower than 5 W, there is a risk that the valve does not work. If R is greater than 30 W, heat generation increases and electric power consumption becomes excessive. Preferably, the coils are used in parallel circuit. Preferably, the 10-20 W coils are used in parallel circuit. The valve operation by the magnet coil can be carried out by a concise circuit of PWM (Pulse Width Modulation) control by PIC (Peripheral Interface Controller), for example the circuit shown in FIG. 3.

Electric power consumption can be decreased by lowering the impressed voltage at a certain time after the start of valve operation. Moreover, the time of the impressed voltage descent can be arbitrarily set in the voltage control resistance circuit, and it can be compliant against the high-voltage regulation, such as in the coolant valve. In particular, great energy savings are possible when many coolant valves are used.

FIG. 4 shows an example of the voltage wave obtained by the VCR circuit. Preferably, at about one second after valve ON, the voltage is decreased from an initial voltage to a holding voltage. This timing can be changed. An initial voltage can be 24 V and the holding voltage can be 17 V. An initial electric power consumption can be 19.2 W and holding electric power consumption can be 9.52 W. That is, the voltage can be decreased by 30% and the electric power consumption can be decreased by almost half

### EXPLANATION OF NUMERALS

1: Valve body
2: Seat
3: Poppet
4: Movable core
5: Fixed core
6: Guide
7: Spacer
8: End cover
9: Needle
10: Stopper
11: Coil
12: Elastic component
13: Coolant discharging opening
20: Surface
21: Surface
22: Stepwise part of the fixed core
23: Stepwise part of the needle
24: Coolant inflow opening

1. A roll coolant valve adapted to use coolant stored exterior thereto, said valve comprising a valve body that comprises a channel in communication with said stored coolant, an end cover disposed in an end of said valve body to form a cavity having a coolant discharge opening, an annular hollow coil arranged along the inner sidewall of said valve body, a fixed core that comprises a hollow disk portion and a hollow cylindrical portion extending rearwardly therefrom, a movable core being arranged in a cavity to slide along the inner surface of said annular hollow coil and comprising a needle arranged to slide along an inner surface of said hollow cylindrical portion of said fixed core, an elastic component, a poppet having an opening that penetrates therethrough at its center and being arranged to slide in said valve body, and a power supply circuit adapted to supply electric power to the coil,
wherein a rear surface of said disk portion of said fixed core being arranged to contact a front edge surface of said coil, the surface of said disk portion being arranged at an essentially right angle relative to a longitudinal direction of said valve body, said hollow cylindrical portion of said fixed core being arranged to contact an inner surface of said annular hollow coil and fixed in the cavity,
a front portion of said needle being positioned and shaped so as to be able to contact and close a rear opening of said poppet, and
said hollow cylindrical portion of said fixed core having a thick wall part at a forward portion of said cylindrical portion so as to create a step-wise portion, the needle of said movable core having a thick portion that corresponds to the thick portion of said hollow cylindrical portion so as to create a step-wise portion, said elastic component being provided between the step-wise portion of said fixed core and the step-wise portion of said needle,
wherein a space between the rear end of said movable core and said end cover permits flow of coolant through said channel.

2-4. (canceled)

5. A roll coolant valve according to claim 1, wherein the elastic component is a spring.

6. A roll coolant valve according to claim 8, wherein a spacer is provided in touch with said stopper.

7. A roll coolant valve according to claim 1, wherein a voltage control resistance circuit is provided to said power supply circuit, the voltage control resistance circuit comprising 5-30 W coils connected in parallel.

8. The roll coolant valve of claim 1 further comprising a stopper disposed between said end cover and said rear end of said movable core.

9. The roll coolant valve of claim 8 wherein the elastic component is a spring.

10. The roll coolant valve of claim 8 wherein a spacer is provided in touch with said stopper.

11. The roll coolant valve of claim 8 wherein a voltage control resistance circuit is provided to said power supply circuit, the voltage control resistance circuit comprising 5-30 W coils connected in parallel.

12. The roll coolant valve of claim 1 further comprising a guide provided on an inner surface of said coil, said rear surface of said basic disk being arranged to contact said guide as well as a front edge surface of said coil, said hollow cylindrical portion of said fixed core being arranged to contact said guide and said movable core arranged to slide along said guide.

13. The roll coolant valve of claim 12 wherein the elastic component is a spring.

14. The roll coolant valve of claim 12 wherein a voltage control resistance circuit is provided to said power supply circuit, the voltage control resistance circuit comprising 5-30 W coils connected in parallel.

15. The roll coolant valve of claim 12 further comprising a stopper disposed between said end cover and said rear end of said movable core.

16. The roll coolant valve of claim 15 wherein the elastic component is a spring.

17. The roll coolant valve of claim 15 wherein a spacer is provided in touch with said stopper.

18. The roll coolant valve of claim 15 wherein a voltage control resistance circuit is provided to said power supply circuit, the voltage control resistance circuit comprising 5-30 W coils connected in parallel.
